(19) United States
(12) Patent Application Publication
(10) Pub. No.: US 2016/0152820 A1
(43) Pub. Date: Jun. 2, 2016

(54) Reinforced Epoxy Nanocomposites and Methods for Preparation Thereof

(71) Applicant: Purdue Research Foundation, West Lafayette, IN (US)

(72) Inventors: Jeffrey Paul YOUNGBLOOD, Crawfordsville, IN (US); Robert John MOON, Marietta, GA (US); Shane Xiufeng PENG, West Lafayette, IN (US)

(21) Appl. No.: 14/946,641

(22) Filed: Nov. 19, 2015

Related U.S. Application Data
(60) Provisional application No. 62/083,028, filed on Nov. 21, 2014.

(51) Int. Cl. C08L 63/00; B29C 35/02; B29C 39/00; C08G 59/24; C08G 59/50

(52) U.S. Cl. CPC C08L 63/00; C08G 59/245; C08G 59/502; B29C 39/003; B29C 35/02; B29K 2201/08; B29K 2063/00

(57) ABSTRACT

The invention relates to reinforced epoxy nanocomposites, for example, cellulose nanocrystal (CNC)/epoxy nanocomposites, and methods for preparation thereof.

### CROSS REFERENCE TO RELATED APPLICATIONS

This application claims the benefit from U.S. Provisional Patent Application Ser. No. 62/083,028, filed on Nov. 21, 2014, which is incorporated herein by reference in its entirety.

### GOVERNMENT INTEREST STATEMENT

This invention was made with government support under DGE1144843 awarded by the National Science Foundation, under FA9550-11-1-0162 awarded by the United States Air Force Office of Scientific Research (USAF/AFOSR), and under 11-JV-11111129-118 awarded by the United States Department of Agriculture. The government has certain rights in the invention.

### TECHNICAL FIELD

This invention relates to reinforced epoxy nanocomposites, for example, cellulose nanocrystal (CNC)/epoxy nanocomposites, and methods for preparation thereof.

### BACKGROUND

The scarcity of fossil fuel and the urgency of environment protection have driven composite research towards the development of renewable and sustainable natural fiber-based composites. Some of the key advantages of natural fiber-based composites over petroleum-based polymer and traditional composites include weight reduction, low cost, ease of recycling, and environmental friendliness. Flax, jute, hemp, and sisal fibers are just a few examples of natural fibers used in composite applications. Among different types of natural fibers, cellulose-based nanomaterials are a new class of natural nanoparticles widely studied in the field of polymer nanocomposites.

Cellulose nanocrystals (CNCs) are cellulose-based nanoparticles that can be extracted via acid hydrolysis from biological sources, such as trees and plants. These cellulose nanocrystals have high aspect ratio (3-10 nm wide and 50-500 nm long), low density, and a high degree of crystallinity. Their axial elastic modulus (E_{A}=100-220 GPa) and tensile strength (Estimated σ_{f}=7.5 GPa) are higher than typical filler materials such as glass fiber and Kevlar. As a result, the properties of CNCs have led to research using CNCs as reinforcing materials for a variety of thermoplastic and thermosetting polymers including polyethylene, poly(lactic acid), poly(vinyl acetate), poly(vinyl alcohol), and polyurethanes.

The hydrophilic nature of CNCs has created difficulties when the CNCs are dispersed into hydrophobic polymer matrices. To disperse CNCs into a polymer matrix, three approaches have been used. One approach is chemical modification of CNCs surfaces to introduce hydrophobic side groups, which have been shown to improve CNC loading efficiency. However, this method requires extra steps and there is a loss of raw materials during the process. Another approach is utilizing water-borne polymers, in which emulsion of hydrophobic polymers or water dilution of hydrophilic polymers are chosen as the matrix materials to increase compatibility. In this method, CNC can be easily dispersed. Excess water, however, is required to emulsify or dissolve the polymer. Further, solvent-assisted dispersion uses organic solvents to reduce the viscosity of a give polymer system, which facilitates dispersion and mixing of CNCs within the polymer. However, there are environmental concerns related to emission of organic solvents. Overall, based on the choice of polymer and the final application, the proper CNC dispersion method should be selected when designing the CNC/polymer nanocomposites.

Epoxy is one of the most commonly used high performance thermosetting resins. Applications for epoxy can be found in the fields of aerospace, electronics, automobile, and construction. Most epoxy resins consist of two components: epoxy monomer and hardener/crosslinking agent. They are usually shipped separately and mixed at the point of use. There are various types of hardeners with amine, hydroxyl, or carboxyl active groups. The type of hardeners determines the crosslinking density and eventual physical properties of the cured epoxy.

Previous studies on CNC/epoxy nanocomposites have used various aromatic and aliphatic amine hardeners (Lu, et al. Compos. Part B Eng. 2013, 51, 28-34; Xu, et al. Polymer 2013, 54, 6589-6598; Ruiz, et al. Macromol. Symp. 2001, 169, 211-222; Pan, et al. Appl. Mech. Mater. 2012, 174-177, 761-766; and Tang, et al. ACS Appl. Mater. Interfaces 2010, 2, 1073-1080). Most of these studies reported that the additions of CNCs to epoxy enhanced the mechanical properties of epoxy both in the glassy and rubbery states, and also increased the glass transition temperature (T_{g}). However, there have not been any known studies that have used hardeners as the CNC dispersant to increase CNC dispersion within epoxy. There is a still unmet need for an alternate approach for the preparation of CNC/epoxy nanocomposites.

### SUMMARY OF THE INVENTION

In one aspect, the present invention provides a method for preparing a reinforced epoxy nanocomposite.

In another aspect, the present invention provides a method for preparing a cellulose nanocrystal (CNC)/epoxy nanocomposite, the method comprising:
a) providing a CNC/hardener/solvent suspension;
b) mixing the CNC/hardener/solvent suspension with an epoxy to form a CNC/hardener/solvent-epoxy mixture; and
c) removing the solvent from the CNC/hardener/solvent-epoxy mixture, followed by curing to form the cellulose nanocrystal (CNC)/epoxy nanocomposite.

In some embodiments, the method of the invention further comprises a step of casting the CNC/hardener/solvent-epoxy mixture in a mold, for example, prior to the removing and curing of step (c).

In some embodiments, the CNC/hardener/solvent suspension in the method of the invention is prepared by
a) dispersing a CNC in water to form a CNC/water suspension;
b) adding a solvent to the CNC/water suspension to form a CNC/solvent organogel;
c) removing water from the CNC/solvent organogel;
d) adding a hardener to the CNC/solvent organogel; and
e) redispersing the CNC/acetone organogel in the hardener to form the CNC/hardener/solvent suspension.

In another aspect, the present invention provides a cellulose nanocrystal (CNC)/epoxy nanocomposite prepared by the method of the invention. In some embodiments, the cellulose nanocrystal (CNC) in the (CNC)/epoxy nanocomposite of the invention is in an amount of from about 0.4 wt % to about 2.05 wt %. In some embodiments, the epoxy nanocomposite is cured by Jeffamine D400 (JD400), diethylenetriamine (DETA), or (±)-trans-1,2-diaminocyclohexane (DACH).

The details of one or more embodiments of the invention are set forth in the accompanying the description below. Other features, objects, and advantages of the invention will be apparent from the description and drawings, and from the claims.

### BRIEF DESCRIPTION OF THE DRAWINGS

FIGS. 1a-1c depict the chemical structures of hardeners. FIG. 1a shows the chemical structure of JD 400; FIG. 1b shows the chemical structure of DETA; and FIG. 1C shows the chemical structure of DACH.

FIGS. 2a and 2b illustrate the CNC/acetone/hardener suspensions under two crossed polarizers. The suspension in FIG. 2a was used to fabricate a 0.56 wt % CNC/epoxy nanocomposite; and the suspension in FIG. 2b was used to fabricate a 1.16 wt % CNC/epoxy nanocomposite.

FIGS. 3a-3c illustrate the polarized light microscopy images of CNC/epoxy nanocomposite specimens cured with DETA. FIG. 3a: neat epoxy; FIG. 3b: 0.56 wt % CNC; and FIG. 3c: 1.16 wt % CNC (scale bar=1 mm).

FIGS. 4a-4d depict the mechanical properties of CNC/epoxy nanocomposites cured with JD400. FIG. 4a is for tensile modulus; FIG. 4b is for tensile strength and yield; FIG. 4c is for strain-at-failure; and FIG. 4d is for work-of-fracture. The squares are CNC-containing specimens; the dots are specimens cured with equivalents amount of acetone (EQA) as the CNC specimens; the solid. symbols represent yield strength (σ_{y}); and the hollow symbols represent fracture strength (σ_{f}).

FIGS. 5a-5d depcit the mechanical properties of CNC/epoxy nanocomposites cured with DETA. FIG. 5a depicts results for the tensile modulus; FIG. 5b is for the tensile strength; FIG. 5c is for the strain-at-fracture; and FIG. 5d is for the work-of-fracture. The squares are CNC-containing specimens; and the dots are specimens cured with EQA as the CNC specimens.

FIGS. 6a-6d depict the mechanical properties of CNC/epoxy nanocomposites cured with DACH: FIG. 6a is for tensile modulus; FIG. 6b is for tensile strength; FIG. 6c is for strain-at-failure; and FIG. 6d is for work-of-fracture. The squares are CNC-containing specimens; and the dots are specimens cured with EQA as the CNC specimens.

FIGS. 7a-7d depict the storage modulus (FIG. 7a), loss modulus (FIG. 7b), tan δ (FIG. 7c), and T_{g} (FIG. 7d) of CNC/epoxy nanocomposites cured with JD400. The squares are CNC-containing specimens; and the dots are specimens cured with EQA as the CNC specimens.

FIGS. 8a-8d depict the storage modulus (FIG. 8a), loss modulus (FIG. 8b), tan δ (FIG. 8c), and T_{g} (FIG. 8d) of CNC/epoxy nanocomposites cured with DETA. The squares are CNC-containing specimens; and the dots are specimens cured with EQA as the CNC specimens.

FIGS. 9a-9d depict the storage modulus (FIG. 9a), loss modulus (FIG. 9b), tan δ (FIG. 9c), and T_{g} (FIG. 9d) of CNC/epoxy nanocomposites cured with DACH. The squares are CNC-containing specimens; and the dots are specimens cured with EQA as the CNC specimens.

FIGS. 10a-10e illustrates side-by-side comparisons of the effects of CNC addition on the properties of epoxy cured with JD400, DETA, and DACH at the same concentrations. FIG. 10a is for tensile modulus; FIG. 10b is for tensile strength; FIG. 10c is for strain-at-failure; FIG. 10d is for work-of-fracture; and FIG. 10e is for glass transition temperature.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present invention provides a method for preparing a cellulose nanocrystal (CNC)/epoxy nanocomposite, the method comprising:
a) providing a CNC/hardener/solvent suspension;
b) mixing the CNC/hardener/solvent suspension with an epoxy to form a CNC/hardener/solvent-epoxy mixture; and
c) removing the solvent from the CNC/hardener/solvent-epoxy mixture, followed by curing to form the cellulose nanocrystal (CNC)/epoxy nanocomposite.

In some embodiments, the method of the invention further comprises a step of casting the CNC/hardener/solvent-epoxy mixture in a mold prior to step (c).

In some embodiments, the solvent in the method of the invention is a water-miscible organic solvent known in the art. For example, the water-miscible solvent that can be used in the method of the invention includes, but is not limited to, methanol, ethanol, ethylene glycol, acetone, tetrahydrofuran, and methylethylketone. In some embodiments, the solvent is tetrahydrofuran. In other embodiments, the solvent is methylethylketone. In certain embodiments, the solvent is acetone. In some embodiments, the water-miscible organic solvent may be used singly or in combination of two or more.

The epoxy of the present invention includes, but is not limited to, a novolac based epoxy resin, a bisphenol A based epoxy resin, a bisphenol F based epoxy resin, a biphenyl based epoxy resin, a triphenylmethane based epoxy resin, and a phenol aralkyl based epoxy resin. In some embodiments, the epoxy is a bisphenol A based epoxy resin. In other embodiments, the epoxy is a bisphenol F based epoxy resin. In certain embodiments, the epoxy is bisphenol A diglycidyl ether resin (2,2-bis(4-glycidyloxyphenyl)propane). These epoxy resins may be used singly or in combination of two or more.

The hardener of the present invention can be aromatic or aliphatic amine hardeners known in the art. In some embodiments, the hardener for the invention contains one amino group. In certain embodiments, the hardener of the invention contains two or three amino groups. In some embodiments, the hardener is a polyether based amine. In other embodiments, the hardener is diethylenetriamine (DETA), Jeffamine D4000 (JD400), or (±)-trans-1,2-diaminocyclohexane (DACH).

In some embodiments, the cellulose nanocrystal (CNC) in the method of the invention is freeze-dried. In other embodiments, the cellulose nanocrystal (CNC) in the method of the invention can be used without additional drying.

In some embodiments, the removing of the solvent in the method of the invention is achieved by degassing. In some embodiments, the degassing, for example, under vacuum, can remove residual solvents and air bubbles simultaneously.

In some embodiments, the step of curing in the method of the invention is conducted at a temperature of from about 50° C. to about 200° C. In other embodiments, the curing is conducted at a temperature of from about 60° C. to about 180° C.

In some embodiments, the casting in a mold in the method of the invention, followed by curing, can prepare a plurality of sheets, films, or fibers depending on the mold used in the method of the invention.

In some embodiments, the CNC/hardener/solvent suspension in the method of the invention is prepared by
a) dispersing a CNC in water to form a CNC/water suspension;
b) adding a solvent to the CNC/water suspension to form a CNC/solvent organogel;
c) removing the water from the CNC/solvent organogel;
d) adding a hardener to the CNC/solvent organogel; and
e) redispersing said CNC/acetone organogel in the hardener to form the CNC/hardener/solvent suspension.

In some embodiments, the redispersing of step (e) is achieved by sonification.

In some embodiments, the formed CNC/water suspension in the method of the invention has a concentration of from about 2 wt % to about 5 wt %. In some embodiments, the formed CNC/water suspension has a concentration of from about 2 wt % to about 7 wt %. In some embodiments, the formed CNC/water suspension has a concentration of from about 2 wt % to about 9 wt %. In some embodiments, the formed CNC/water suspension has a concentration of from about 2 wt % to about 10 wt %. In some embodiments, the formed CNC/water suspension has a concentration of from about 2 wt % to about 15 wt %. In some embodiments, the formed CNC/water suspension has a concentration of from about 2 wt % to about 20 wt %.

In some embodiments, the formed CNC/water suspension in the method of the invention has a concentration of from about 4 wt % to about 9 wt %. In some embodiments, the formed CNC/water suspension has a concentration of from about 4 wt % to about 7 wt %. In some embodiments, the formed CNC/water suspension has a concentration of from about 5 wt % to about 9 wt %. In some embodiments, the formed CNC/water suspension has a concentration of from about 5 wt % to about 7 wt %. In certain embodiments, the formed CNC/water suspension has a concentration of about 5 wt %.

In some embodiments, the solvent in the CNC/solvent organogel is calculated gravimetrically. In some embodiments, the amount of the solvent that is added to the hardener and the epoxy in the method of the invention is the same amount as the solvent in the CNC/solvent organogel. In some embodiments, no solvent is added to the hardener. In other embodiments, no solvent is added to the epoxy.

In some embodiments, the amount of the cellulose nanocrystals (CNCs) used in the method of the invention is from 0 to about 10 parts by mass based on 100 parts by mass of the hardener. In some embodiments, the amount of the cellulose nanocrystals used is from about 1 part to about 10 parts by mass based on 100 parts by mass of the hardener. In other embodiments, the amount of the cellulose nanocrystals used is from about 2 parts to about 10 parts by mass based on 100 parts by mass of the hardener. In some embodiments, the amount of the cellulose nanocrystals used is from about 4 parts to about 10 parts by mass based on 100 parts by mass of the hardener. In other embodiments, the amount of the cellulose nanocrystals used is from about 5 parts to about 10 parts by mass based on 100 parts by mass of the hardener. In certain embodiments, the amount of the cellulose nanocrystals used is from about 8 parts to about 10 parts by mass based on 100 parts by mass of the hardener.

In some embodiments, the amount of the epoxy used in the method of the invention is from about 150.0 parts to about 850 parts by mass based on 100 parts by mass of the hardener. In some embodiments, the amount of the epoxy used in the method of the invention is from about 300 parts to about 850 parts by mass based on 100 parts by mass of the hardener. In some embodiments, the amount of the epoxy used in the method of the invention is from about 600 parts to about 850 parts by mass based on 100 parts by mass of the hardener.

In some embodiments, the amount of the epoxy and the amount of the hardener used in the method of the invention are calculated based on the numbers of the amino group in the hardener and the epoxide group in the epoxy. In some embodiments, the molar ratio of the amino group in the hardener and the epoxide group in the epoxy used in the method of the invention is about 1:1.

The present invention further provides a cellulose nanocrystal (CNC)/epoxy nanocomposite prepared by the method of the invention as described herein. The cellulose nanocrystal (CNC)/epoxy nanocomposite of the invention has improved mechanical properties over an epoxy nanocomposite without reinforcing CNC. In some embodiments, in the (CNC)/epoxy nanocomposite of the invention, the cellulose nanocrystal (CNC) is in an amount of from about 0.4 wt % to about 2.05 wt %.

In some embodiments, the cellulose nanocrystal (CNC) in the nanocomposite of the invention is from about 0.4 wt % to about 1.50 wt %. In other embodiments, the cellulose nanocrystal (CNC) in the nanocomposite of the invention is from about 0.4 wt % to about 1.20 wt %. In some embodiments, the cellulose nanocrystal (CNC) in the nanocomposite of the invention is from about 0.4 wt % to about 1.0 wt %. In certain embodiments, the cellulose nanocrystal (CNC) in the nanocomposite of the invention is from about 0.4 wt % to about 0.9 wt %. In some embodiments, the cellulose nanocrystal (CNC) in the nanocomposite of the invention is from about 0.4 wt % to about 0.7 wt %. In some embodiments, the cellulose nanocrystal (CNC) in the nanocomposite of the invention is from about 0.4 wt % to about 0.6 wt %. In certain embodiments, the cellulose nanocrystal (CNC) in the nanocomposite of the invention is from about 0.5 wt % to about 1.0 wt %. In other embodiments, the cellulose nanocrystal (CNC) in the nanocomposite of the invention is from about 0.6 wt % to about 1.0 wt %. In some embodiments, the cellulose nanocrystal (CNC) in the nanocomposite of the invention is from about 0.7 wt % to about 1.0 wt %.

In some embodiments, the (CNC)/epoxy nanocomposite of the invention is cured by Jeffamine D400 (JD400), diethylenetriamine (DETA), or (±)-trans-1,2-diaminocyclohexane (DACH). In certain embodiments, the (CNC)/epoxy nanocomposite of the invention is cured by diethylenetriamine (DETA). In other embodiments, the (CNC)/epoxy nanocomposite of the invention is cured by Jeffamine D400 (JD400). In some embodiments, the (CNC)/epoxy nanocomposite of the invention is cured by (±)-trans-1,2-diaminocyclohexane (DACH).

In some embodiments, the cellulose nanocrystal (CNC) in the nanocomposite of the invention is about 0.6 wt % and wherein the epoxy nanocomposite is cured by diethylenetriamine (DETA).

In some embodiments, the epoxy in the epoxy nanocomposite of the invention is bisphenol A diglycidyl ether resin. In some embodiments, the Young's modulus of the (CNC)/epoxy nanocomposite of the invention is increased by from about 15% to about 20% compared with an epoxy nanocomposite without reinforcing cellulose nanocrystals (CNC).

The present invention further provides materials comprising the CNC/epoxy composite of the invention. Such materials have many potential areas of uses including food or biomedical applications. The materials can be molded to sheets, films, and fibers.

In some embodiments, the present invention provides a method for preparing CNC/epoxy nanocomposites, comprising (a) dispersing a freeze-dried CNC in deionized water to reach 5 wt % suspension to achieve a CNC water suspension; (b) adding a solvent to the CNC water suspension, resulting in a top solvent layer and a bottom solvent layer; (c) creating a CNC/solvent organogel by replacing the top solvent layer with fresh solvent about every 24 hours; (d) adding a hardener to the CNC/solvent organogel to create a CNC/solvent organogel-in-hardener organogel; (e) redispersing the CNC/solvent organogel-in-hardener organogel in a hardener to create a CNC/hardener/solvent suspension; (f) mixing the CNC/hardener/solvent suspension with Diglycidyl ether of bisphenol-A (DGEBA) to create a CNC/hardener/solvent-DGEBA mixture; (g) casting the CNC/hardener/solvent-DGEBA mixture in a mold to create a plurality of sheets; and (h) curing the sheets. In some embodiments, the method comprises a step of degassing the sheets under vacuum. In some embodiments, the solvent of the method of the present invention is acetone. In other embodiments, the solvent of the method of the present invention is tetrahydrofuran.

In some embodiments, the method of the present invention comprises a step of pulling the solvent before mixing with epoxy. In some embodiments, the method of the present invention is carried out in a solvent-free environment.

The present invention provides a new approach to produce cellulose nanocrystals (CNC)/epoxy nanocomposites, where CNCs are first dispersed in the hardeners before mixing with epoxy resin. By pre-formulating the hardeners with CNCs, stable suspensions of CNC, hardeners, and acetone are achieved. The Young's modulus and tensile strength of the produced (CNC)/epoxy nanocomposites are improved, although the reinforcing effects of CNC were hardener dependent. For example, the DETA cured epoxy by the method of the invention shows increased tensile modulus, tensile strength, strain-at-failure, and work-of-fracture of ˜20%, ˜15%, ˜25%, and ˜100%, respectively at their highest at a 0.56 wt % CNC addition. The presence of acetone before curing embrittles the epoxy. However, CNC additions counteract this effect by maintaining the strain-at-failure of the epoxy resin. Dynamic mechanical analysis indicates that the addition of water and acetone could alter the degree of curing. CNCs were able to preserve the mechanical properties of epoxy despite the plasticization effect of water.

Symbols and notations as used in the present disclosure are briefly described herein.

E=Young's modulus;

σ_{f}=Tensile strength/Fracture strength;

σ_{y}=Yield strength;

ε_{f}=Strain-at-failure;

γ_{wof}=Work-of-fracture;

T_{g}=Glass transition temperature;

E′=Storage modulus; and

E″=Loss modulus.

In some embodiments, the term “epoxy nanocomposite” refers to the nanocomposite composition formed with epoxy resins, hardeners, and CNCs. In some embodiments, the term may refer to the aforementioned nanocomposite after curing. In other embodiments, the term may refer to the aforementioned nanocomposite in a state prior to curing; such use will be clear at the time it is discussed.

In some embodiments, the term “epoxy” refers to “epoxy resin” as known in the art.

### EXPERIMENTAL

### Materials

Acetone was purchased from Marcon Fine Chemicals, Center Valley, Pa., USA. Epoxy resin (Diglycidyl Ether of Bisphenol-A (DGEBA), Equivalent Epoxy Weight (EEW)=172-176), JD400 (Mw ˜400, Amine Hydrogen Equivalent Weight (AHEW)=100), DETA (AHEW=20.6), and DACH (AHEW=28.5) were purchased from Sigma-Aldrich, St Louis, Mo., USA. All materials were used as purchased. The silicone rubber mold was created using Mold Max 40 silicone rubber from Smooth-on, Easton, Pa., USA. CNC was provided by USDA Forest Service-Forrest Products Laboratory, Madison, Wis., USA.

### Tensile Testing

Tensile testing was conducted using a universal tensile testing machine (MTS insight, MTS System Corp., Eden Prairie, Minn., USA). Tensile specimens were prepared by laser cutting tensile specimens from a 12.7 cm×12.7 cm sheet following ASTM 638-10 Type IV sample dimensions and proportionally decreased by 2.27 times. The specimens were sanded to achieve a thickness close to 1 mm. Tests were completed in displacement control at rate of 5 mm/min. Five to ten replicates were tested for each type of specimen. The average and standard deviations were reported. Student t-tests were conducted on Young's modulus, ultimate tensile strength, work-of-fracture, and strain-at-failure data to determine statistical significance. The threshold level was set at 0.05.

### Dynamic Mechanical Analysis (DMA)

Storage modulus, loss modulus, and tan 6 were measured using DMA Q800 (TA instruments, New Castle, Del., USA) under single cantilever mode. Specimens were laser cut into 12.78 mm×35.64 mm bars. The DETA hardened specimens were heated from room temperature to 200° C. at a rate of 3° C./min under nitrogen atmosphere. The DETA hardened specimens were heated from room temperature to 250° C. at a rate of 3° C./min under nitrogen atmosphere. The JD400 hardened specimens were heated from 20° C. to 150° C. at a rate of 3° C./min under nitrogen atmosphere. The specimens were tested at 15 μm strain and 1 Hz frequency.

### Polarized Light Microscopy

The cured specimens were observed using a Carl Zeiss inverted microscope equipped with two crossed polarizers. The specimens were sanded to remove surface defects. Images were taken when polarizers were at full extinction.

### Example 1

### CNC/Epoxy Nanocomposite Preparation

CNC/hardener/acetone suspensions were created for all three types of hardeners at various concentrations of CNCs. In detail, freeze-dried CNCs were first dispersed in deionized water to reach 5 wt % suspension. Following the previous solvent exchange sol-gel process developed for dispersing CNCs in polymer by Capadona et al (Nat. Nanotechnol. 2007, 2, 765-769), 15 mL of acetone was added to 2 mL of CNC water suspension. To create the CNC/acetone organogel, the top acetone layer was replaced with fresh acetone every 24 hours. After 48 hours, the hardener was added to the CNC/acetone organogel and allowed to immerse for one hour. The CNC/acetone organogel was then redispersed in hardener using a sonifier (S-250D, Branson Ultrasonics Corp., Danbury, Conn., USA) at 25% amplitude and one-second on/off cycles until a transparent suspension was achieved.

The CNC/hardener/acetone suspension was mixed with DGEBA using a vortexer (VWR, West Chester, Pa., USA) under 1:1 amine to epoxide ratio. The mixture was casted in a silicone rubber mold to create 12.7 cm×12.7 cm sheets. The specimens were degassed under vacuum to remove the residual acetone and air bubbles. The JD400 and DETA specimens were cured at 60° C. for 12 hours, followed by 80° C. for 2 hours, and then 125° C. for 3 hours. The DACH specimen were cured at 60° C. for 12 hours, followed by 80° C. for 1 hours, and then 177° C. for 2 hours.

### Example 2

### Equivalent Acetone (EQA) Specimen Preparation

The residual acetone in CNC/acetone organogel was calculated gravimetrically. The same amount of acetone was added to hardeners and DGEBA during mixing to create the corresponding EQA specimens. Acetone was subsequently removed during the degassing step. The EQA specimens were cured following the same procedure as their corresponding CNC specimens. All types of specimens created were listed in Table 1.

TABLE 1
Summary of Nanocomposite Compositions

| | | | | | Acetone | |
|---|---|---|---|---|---|---|
| | | Nanocmposite | | | content | Wt % |
| | | composition (per | | | before | of CNC |
| | Hard- | 100 part hardener) | | | degas (per | in final |
| | ener | | Hard- | Ep- | 100 part | nano- |
| Sample type | type | CNC | ener | oxy | hardener) | composite |
| JD400_neat | JD400 | | 100 | 151.5 | | |
| JD400_C_0·4 | | 1 | 100 | 151.5 | 15 | 0.4 |
| JD400_C_1·21 | | 3 | 100 | 151.5 | 56 | 1.21 |
| JD400_C_2·05 | | 5 | 100 | 151.5 | 93 | 2.05 |
| JD400_A_0·4 | | | 100 | 151.5 | 15 | |
| JD400_A_1·21 | | | 100 | 151.5 | 56 | |
| JD400_A_2·05 | | | 100 | 151.5 | 93 | |
| DETA_neat | DETA | | 100 | 843.2 | | |
| DETA_C_0·4 | | 3.65 | 100 | 843.2 | 40 | 0.4 |
| DETA_C_0·56 | | 5 | 100 | 843.2 | 60 | 0.56 |
| DETA_C_0·91 | | 8 | 100 | 843.2 | 88 | 0.91 |
| DETA_C_1·16 | | 10 | 100 | 843.2 | 197 | 1.16 |
| DETA_A_0·4 | | | 100 | 843.2 | 40 | |
| DETA_A_0·56 | | | 100 | 843.2 | 60 | |
| DETA_A_0·91 | | | 100 | 843.2 | 88 | |
| DETA_A_1·16 | | | 100 | 843.2 | 197 | |
| DACH_neat | DACH | | 100 | 609.8 | | |
| DACH_C_0·4 | | 2.77 | 100 | 609.8 | 30 | 0.4 |
| DACH_C_0·74 | | 5 | 100 | 609.8 | 60 | 0.74 |
| DACH_C_1·21 | | 8 | 100 | 609.8 | 158.4 | 1.21 |
| DACH_C_1·54 | | 10 | 100 | 609.8 | 198 | 1.54 |
| DACH_A_0·4 | | | 100 | 609.8 | 30 | |
| DACH_A_0·74 | | | 100 | 609.8 | 60 | |
| DACH_A_1·21 | | | 100 | 609.8 | 158.4 | |
| DACH_A_1·54 | | | 100 | 609.8 | 198 | |

### Example 3

### Dispersion of CNCs in Hardeners

Good dispersion of CNCs within epoxy is necessary to maximize performance of the resulting CNC/epoxy nanocomposite. CNC/epoxy nanocomposites are generally prepared through co-mixing epoxy, hardeners, and CNCs in situ. In the method of the present invention, a approach was taken by dispersing CNCs in hardeners first before mixing with epoxy resin. Bisphenol A (BPA) based epoxy is generally hydrophobic, which makes CNC dispersion difficult, while the hardeners are typically more hydrophilic. The amine group on the hardeners can form cationically charged moieties that can interact with the negatively charged CNC surface, which may increase CNC dispersion. Once predispersed, the CNCs would then be easier to disperse in the BPA epoxy phase. The hardeners are acting similar to dispersants to minimize aggregation. Additionally, the CNCs may be kinetically trapped by the higher viscosity or form charged complexes leading to higher dispersion. Due to these potential benefits, the predispersion of CNC into the hardeners was performed.

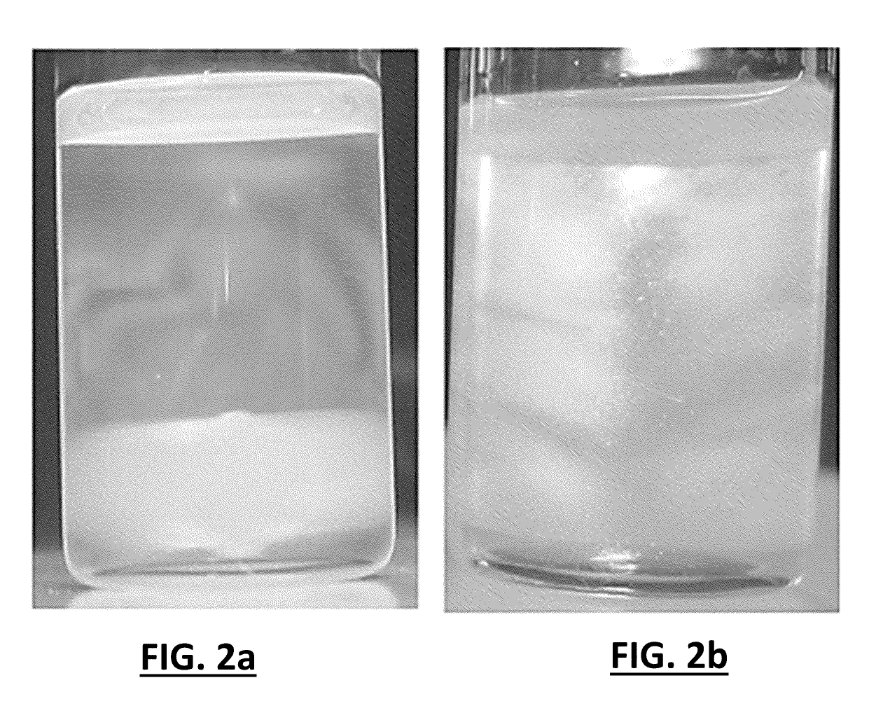

To disperse CNCs within the hardeners, an acetone/water sol-gel solvent exchange method was used (Tang, et al. ACS Appl. Mater. Interfaces 2010, 2, 1073-1080; Capadona, et al. Nat. Nanotechnol. 2007, 2, 765-769). An ultrasonifcation step was required to redisperse the CNC/acetone organogel in hardeners to allow the formation of stable CNC/acetone/hardener suspensions. FIGS. 2a and 2b illustrate the CNC/acetone/hardener suspensions under two crossed polarizers. The suspension in FIG. 2a was used to fabricate a 0.56 wt % CNC/epoxy nanocomposite, while the suspension in FIG. 2b was used to fabricate a 1.16 wt % CNC/epoxy nanocomposite. The suspension in FIG. 2a was a viscous liquid that displayed birefringent effects when agitated with a stir bar. The suspension in FIG. 2b was a soft gel that displayed birefringent effects without agitation. At low CNC contents, the CNC/acetone/hardener suspensions were viscous liquids. The birefringent effects could be observed when the suspension was agitated. According to FIGS. 2a and 2b, as the CNC content increased, the suspensions became more viscous. At higher CNC concentrations, the CNC/acetone/hardner suspensions turned into a soft gel and the birefringent effects were locked in place. The suspensions were shear thinning since agitation could decrease viscosity and break the gel formation.

Similar behaviors were observed in all three types of hardeners. At low CNC concentrations, the birefringent patterns observed in all three hardeners were polychromatic. At similar concentrations, suspensions of CNC in water and other organic solvent suspensions displayed monochromatic patterns. The shear thinning effects of the CNC/acetone/hardener indicated that there was a reversible interaction between CNC, hardener, and acetone. Similar effects were also observed by others in CNC/dimethylsulfoxide (DMSO) suspensions under shear. It is believed that the hydrogen bonding between the amine groups on the hardeners and the hydroxyl groups on the CNC had created a weak and reversible physical interaction.

### Example 4

### Dispersion of CNCs in Epoxy After Curing

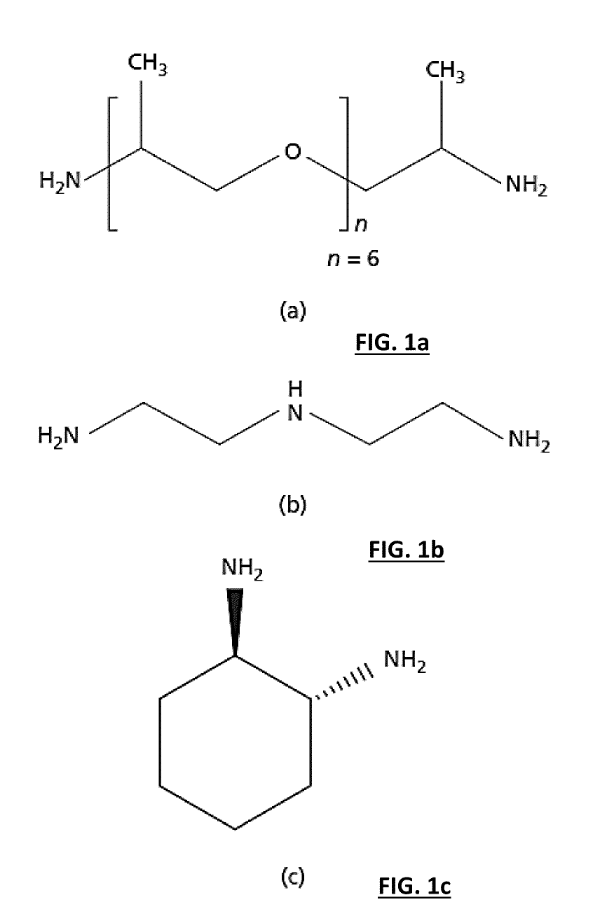

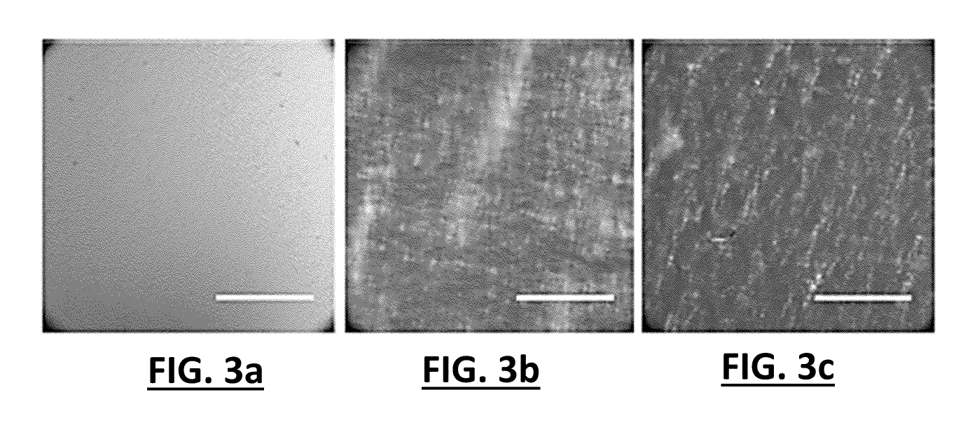

To evaluate the dispersion state of CNCs within the cured epoxy, specimens were evaluated using optical microscope under polarized light. FIGS. 3a-3c are images of cured speciemens when the polarizers were at full extinction. Specifically, FIGS. 3a-3c are polarized light microscopy images of CNC/epoxy nanocomposite specimens cured with DETA. The images corresponded to: neat epoxy (FIG. 3a), 0.56 wt % CNC (FIGS. 3b), and 1.16 wt % CNC (FIG. 3c) (scale bar=1 mm). In the neat epoxy, the birefringent domains were not observed. With increased CNC concentrations, the domain size did not appear to change in size or density. The observation of birefringent domains may be an indication of CNC aggregation. Similar birefringent domains were also observed by Xu et al (Xu, et al. Polymer 2013, 54, 6589-6598), who dispersed wood-derived CNCs in a waterborne epoxy. In this case, the birefringent domains were smaller in size than what was observed in the present study, although the relevance of such size is not clear.

The existence of birefringent domains could also be stress related. Epoxy, even though isotropic in nature, could exhibit birefringent behavior when subjected to stress (Bettany, et al. Br. J. Appl. Phys. 1963, 14, 692-695). Previous studies indicated that shear stress could lead to orientated CNC domains, which may change the birefringent behavior of casted CNC films (Reising, et al. J. Sci. Technol. For. Prod. Process. 2012, 2, 32-41; and Diaz, et al. Biomacromolecules 2013, 14, 2900-2908). There were no noticable change in birefringent effects when specimens were rotated under the microscope. For DETA specimens, the concentration of birefringent domains did not increase as CNC loading increased. While there may be no correlation between the birfriengent domains and CNC aggregation, the posibility of microscale CNC aggregation could not be excluded due to resolution limitations of the optical microscopy used in this disclosure.

### Example 5

### Mechanical Properties of CNC/Epoxy Nanocomposites

In the method of the present invention, CNC/acetone organogels were redispersed in hardeners to create a stable suspension. Aceteone was initially left in the suspension to maintain low viscosity and prevent potential CNC aggregation, and then removed by vacuum after the CNC/acetone/hardener suspensions were mixed with epoxy. Vacuum was also applied on neat epoxy specimens to remove large bubbles generated during mixing. To evaluate the impact of acetone on the nanocomposite system, equivalent acetone (EQA) specimens were created. An equivalent amount of acetone to the CNC/epoxy nanocomposites was added to the neat epoxy during mixing and removed afterward with vacuum. Mechanical and thermal properties of CNC/epoxy nanocomposites and their corresponding EQA specimens were analyzed via tensile testing and dynamic mechanical anaylsis. It is noted that although acetone is used herein as one embodiment of the present disclsoure, other solvents may be used, including tetrahydrofuran (THF). The process may also be conducted in a solvent-free environment.

### JD400

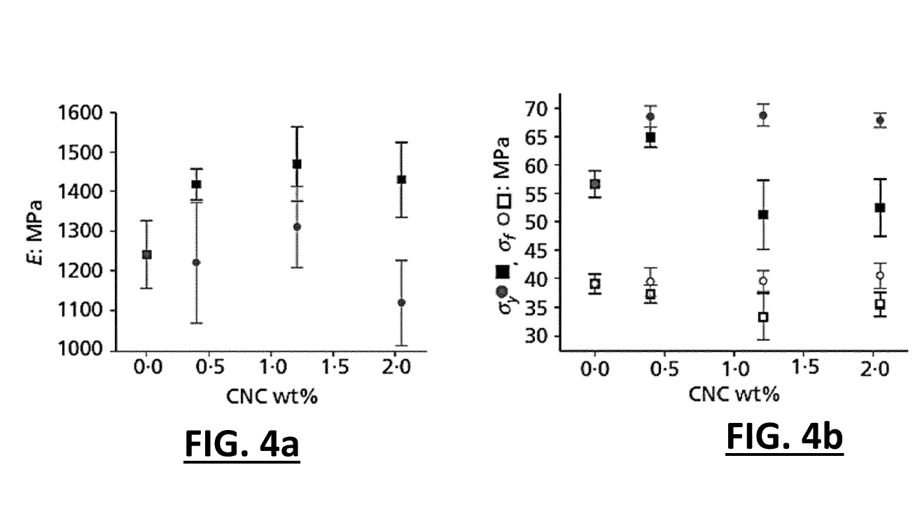

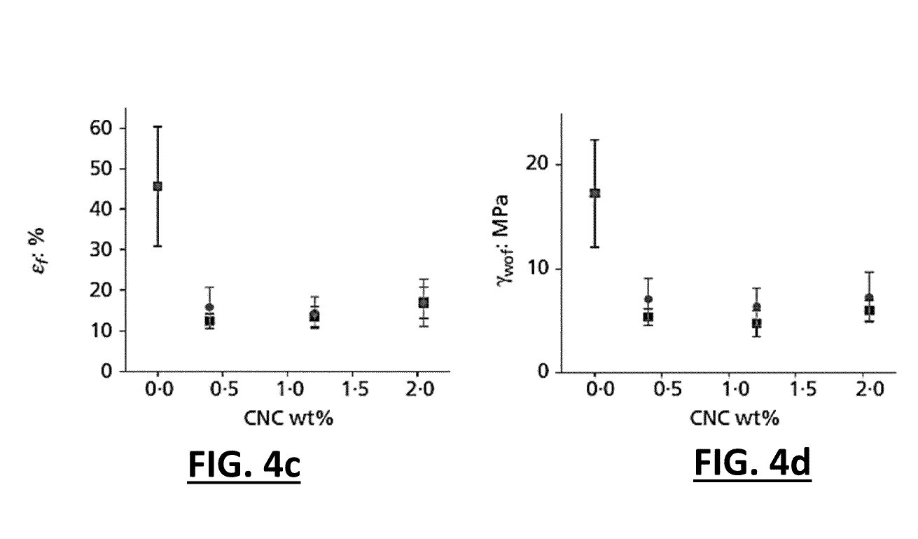

JD400 is a difunctional short chain hardener used to increase flexibility and decrease brittleness of cured epoxy. The hydrophilic oxypropylene repeating units in the backbone and low vicosity can potentially increase CNC dispersion. The tensile properties of the specimens cured with JD400 are shown in FIGS. 4a-4d. Neat epoxy cured with JD400 generated a ductile polymer with high strain-at-failure and work-of-fracture, and a yielding behavior. All of the CNC/epoxy nanocomposites cured with JD400 also exhibited yielding behavior.

FIG. 4a shows a statistically significant enhancement of the Young's modulus of JD400 specimens with CNC additions. To determine the influence of acetone, the Young's modulus was compared between neat epoxy and the EQA specimens, the results indicated minimal impact of acetone on the Young's modulus. Therefore, for the CNC/epoxy nanocomposites, the CNCs were the primary factor causing the modulus improvement.

All specimens cured with JD400 had shown necking behaviors during tensile testing. As shown in FIG. 4b, The EQA specimens had exhibited higher yield strength compared with their corresponding CNC reinforced speciemens. A possible explanation of this difference was that acetone increased the dispersion of JD400 in the epoxy resin by decreasing viscosity, which can subsequently lead to more homogeneous reaction of JD400 with the epoxy resin. For CNC reinforced specimens, the yield strength increased at 0.4 wt % CNC but decreased at 1.21 wt % and 2.05 wt %. Statistical analysis showed that the changes were significant at these points. Also shown in FIG. 4b, the tensile strength of CNC reinforced specimens also decreased when compared with that of the neat specimens. The decrease in yield and tensile strength of CNC reinforced specimens indicated that CNCs acted as defects rather than reinforcment in the nanocomposites at low concentrations.

Similar trends were also observed with the strain-at-failure and work-of-fracture data. As indicated in FIGS. 4c and 4d, the CNC reinforced specimens and EQA specimens resulted in low strain-at-failure and work-of-fracture values in comparison with that of neat specimens. This could be a result of the presence of residual acetone and water before the epoxy curing stages. Also, as vacuum was applied to all specimens, it is plausible that micron-sized bubbles could have been generated during this process. These microvoids could have acted as defects for fracture initiation and subsequent crack propagation. For the acetone containing specimens, more mircoporosity could have been generated at the elevated curing temperature as acetone and water evaporated. This could cause these specimens to become brittle and thus break at a lower strain than neat specimens. Similarly, the low CNC concentration related decrease in tensile strength and strain-at-failure have been previously reported by Xu et al (Polymer 2013, 54, 6589-6598). However, for the strain-at-failure data, no statstically significant differences was found between the CNC specimens and the EQA specimens, indicating that CNCs did not further embrittle the epoxy matrix. The embrittling effects were likely caused by acetone.

### DETA

DETA is a trifunctional small molecule hardener, and is one of the most commonly used epoxy hardeners. DETA has higher amine content than JD400 and DACH, and as such it can potentially form more hydrogen bonds with CNCs to increase dispersion as well as form higher cross-linking denisty networks than JD400 and DACH.

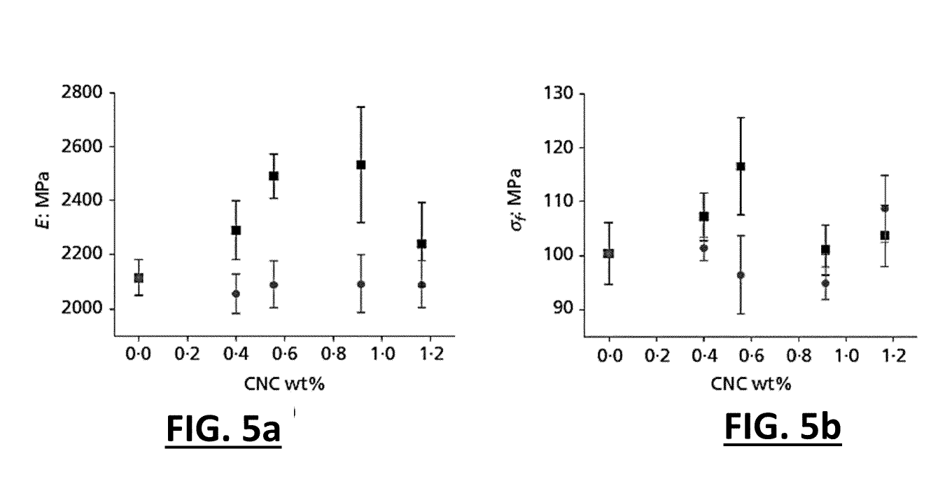

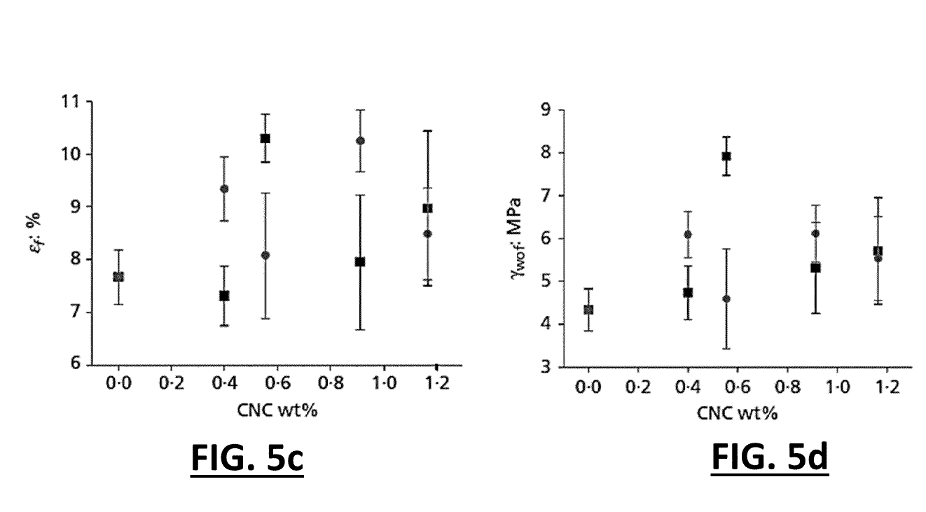

Tensile properties of CNC/epoxy nanocomposites cured with DETA and the corresponding EQA specimens are shown in FIGS. 5a-5d. For Young's modulus, the increases were statistically significant up to 0.92 wt %. At 1.16 wt % CNC, there were no differences between the CNC reinforced specimens and the neat epoxy specimens. When compared to EQA specimens, the CNC reinforced specimens were significantly different. For tensile strength, there was no significant change between the CNC specimens and the neat specimens except the 0.56 wt % CNC specimens. Consequently, the CNC specimens were all significantly different from their corresponding EQA specimens except the 1.16 wt % CNC specimens. The decrease of tensile modulus and strength at 1.16 wt % CNC could be due CNC aggregation.

The strain-at-failure and work-of-fracture data for DETA cured specimens showed similar trends. There were no significant change between CNC specimens and neat specimens except at 0.56 wt % CNC. Unlike JD400 cured specimens, the DETA cured specimens were not embrittled by the addition of CNCs and acetone. This indicates that the more cross-linked epoxy was less likely to be affected by the acetone caused defects. It can be concluded that CNC improved modulus and strength of epoxy while not scarificing ductility. Further, CNC additions to DETA before being incorporation into the epoxy resin simultancously increased Young's modulus, tensile strength, strain-at-failure, and work-of-fracture, which is difficult to achieve in nanocomposites.

### DACH

DACH is a difunctional cycloaliphatic hardener. They are less reactive, therefore are usually cured at higher temperatures and because of this DACH cured specimen can provide additional insights to CNC reinforcing characteristic after a high temperature curing stage. Further, DACH has two active amine groups that are in close proximity to each other, which provide structural variety to the cured epoxy as compared to the other two aliphatic amines. DACH cured epoxies have similar mechanical properties as DETA cured epoxies.

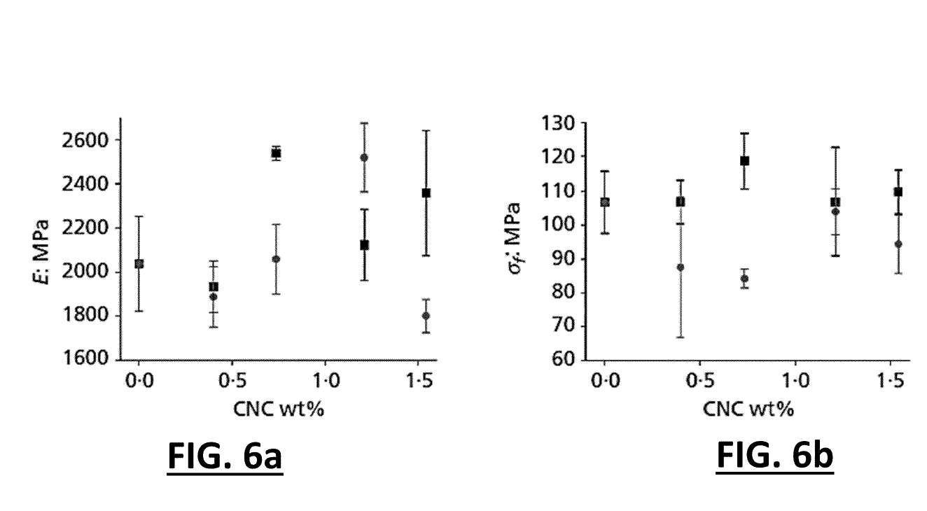

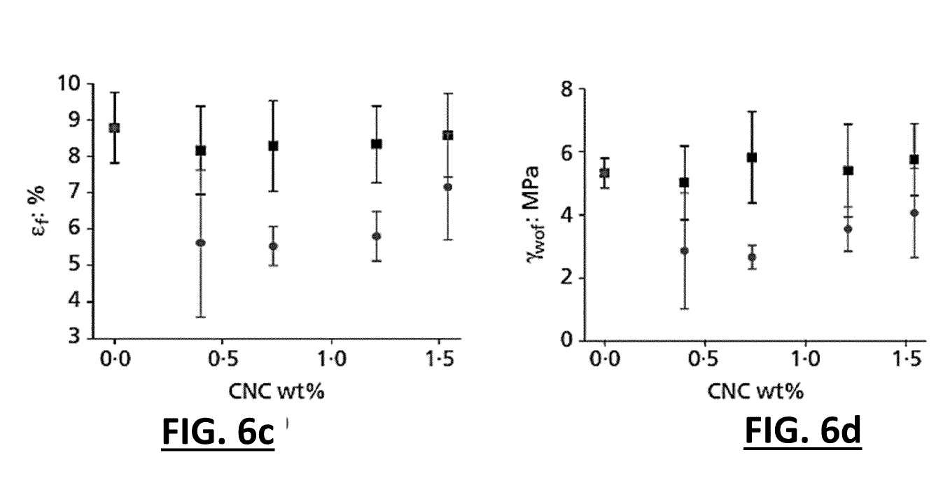

FIGS. 6a-6d show the tensile properties of CNC/epoxy nanocomposites cured with DACH. Statistical analysis indicated no significant change in Young's modulus and tensile strength of all DACH cured specimens except the 0.74 wt % CNC specimens. When compared with the EQA specimens, CNC specimens exhibited higher Young's modulus and tensile strength at 0.74 wt % and 1.54 wt %, while the properties were lower or had no significant change for the 1.21 wt % specimens. For the strain-at-failure and work-of-fracture data, there were no significant difference between the neat and CNC specimens. However, the EQA specimens generally caused lower values in strain-at-failure and work-of-fracture similar to that of JD400 cured EQA specimens. This indicates that defects created by acteone and water during curing caused the specimens to fail more brittlely, and CNC ameliorated the embrittlement effect.

### Example 6

### The Role of Hardener Structure on the CNC Reinforcing Effects

The CNC reinforcing effects depended on the molecular structure of the hardeners and the crosslinking network formed between the epoxy and hardeners. DETA, which has five active amine hydrogens, formed a high density crosslinking network with epoxy. DACH cured epoxies, which were cured at elevated temperature, formed epoxy network with high degree of crosslinking. JD400, due to long crosslinker length, formed flexible epoxy networks with more freedom of movement between polymer chains. As a result, the tensile modulus and strength of the specimen cured with JD400 was lower in comparison with those of the DETA and DACH cured specimens.

Despite the differences in epoxy network structure, Young's modulus were increased for both JD400 cured and DETA cured specimens. Similar improvement of Young's modulus was observed by Xu et al (Polymer 2013, 54, 6589-6598). Xu et al also showed a lowering of strain-at-failure and tensile strength when CNC loading were below 2 wt %. However, in this study, only the JD400 cured specimen exhibited such behavior. This further indicated that the CNC reinforcing effects were hardener dependent. DETA cured specimens had the best combination of mechanical properties improvement among the three hardeners evaluated. The mechanical properties improvement, however, did not increase with CNC loading for CNC content greater than 1% wt. This could result from two possible mechanisms: the formation of CNC aggregation and/or the presence of residual acetone and water that led to increasing numbers of defects and lowering of cross-linking density. A combination of both might also be applied.

It is also worth noticing that the hydrophilic main chain of JD400 was not a factor on the CNC reinforcing effects, since the improvement of Young's modulus were not significantly different between JD400 and DETA cured specimens (16% increase for JD400 and 19% increase for DETA at close to 2 wt % CNC). This indicates the main reinforcing mechansim was physical interactions instead of chemical bonding. The molecular structure of JD400 and DACH indicates higher tendancy to form a more flexible crosslinking network. These flexible networks caused both epoxies to be less flaw tolerant. The maintenance of strain-at-failure of DACH cured specimens indicated that CNC enhanced the flaw tolerance of the epoxy network by preventing defect propagation. For the JD400 cured sample, flaw tolerance did not improve, which was likely due to the ductile nature of JD400 cured epoxy.

The presence of CNCs within the epoxy, while preventing defect propagation, also limited polymer chain movement within the loose cross-linking network and therefore did not maintain high strain-at-failure. However, the reinforcing mechanism could not be clearly identified due to the possible existence of defects created by the residual acetone and water, which could alter the fracture mechanism dramatically. In addition, previous studies indicate that the presence of solvent and water during the epoxy curing could also affect the degree of cure and the curing kinetics of the epoxy resin, which can also influent the mechanical properties. Nevertheless, the mechanical properties of the CNC/epoxy nanocomposites developed in the method of the present invention were not only unaffected but also improved in some hardener systems. This indicates that the CNC reversed the plasticizing effect through its superior mechanical reinforcing efforts.

### Example 7

### Thermal Properties of CNC/Epoxy Nanocomposites

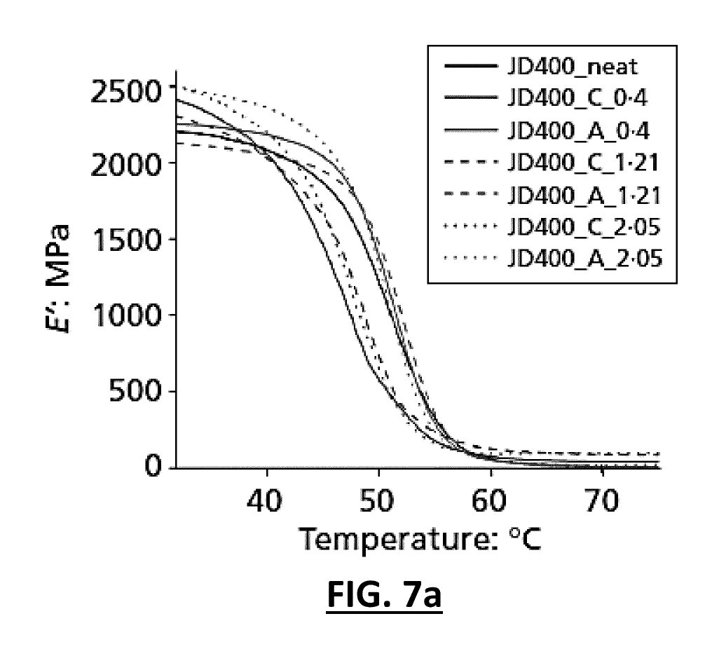

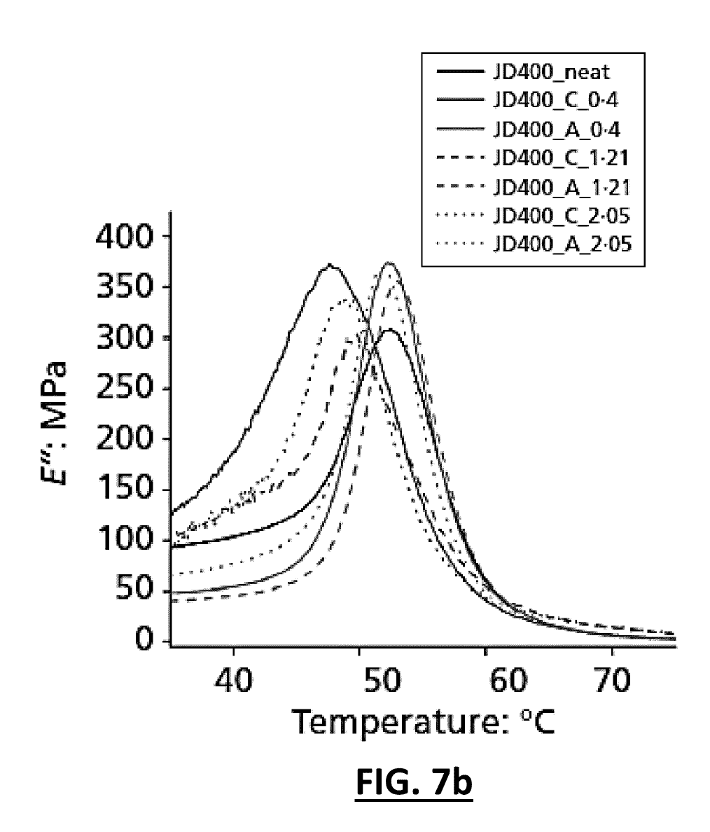

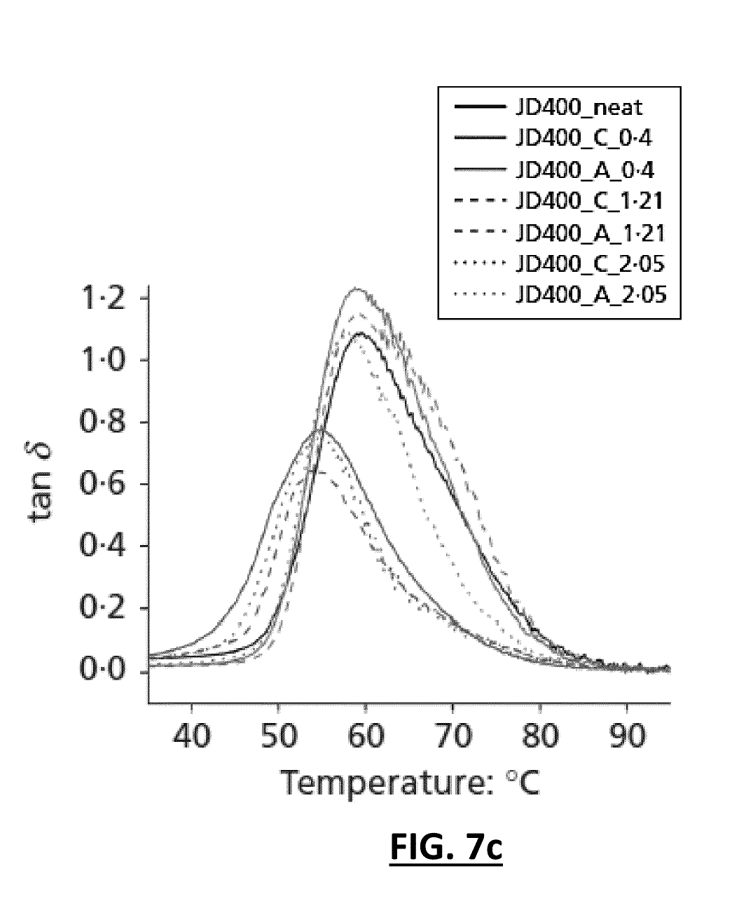

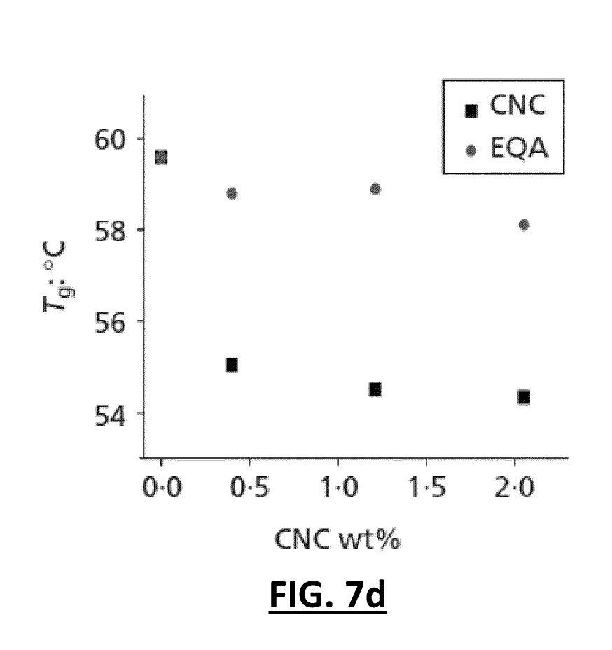

FIGS. 7a-9d present the storage modulus (FIGS. 7a, 8a, and 9a), loss modulus (FIGS. 7b, 8b, and 9b), tan δ (FIGS. 7c, 8c, and 9c), and T_{g} (FIGS. 7d, 8d, and 9d (FIGS. 7d, 8d, and 9d) of CNC/epoxy nanocomposites cured with JD400, DETA, and DACH respectively. T_{g} was calculated with the temperature at the peak of the tan δ curve. For the JD400 cured specimens, the results in FIGS. 7a-7d showed a minor decrease of T_{g} in the EQA specimens, yet all CNC reinforced specimens had more significant lowering of T_{g}.

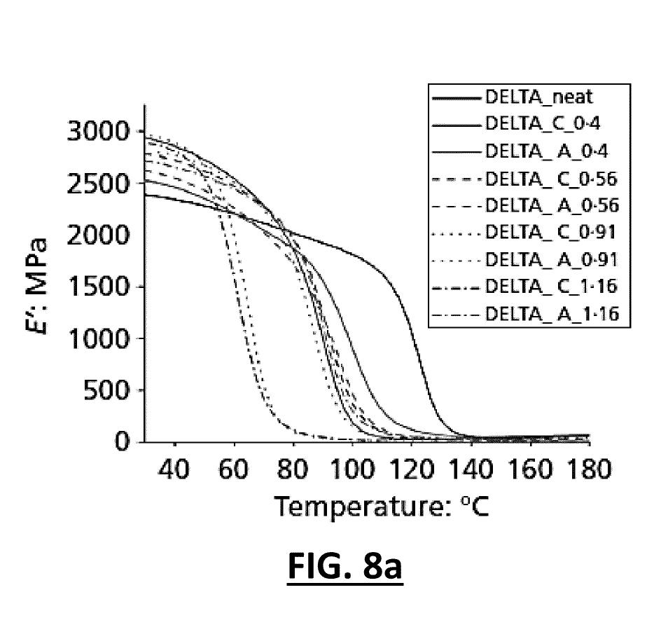

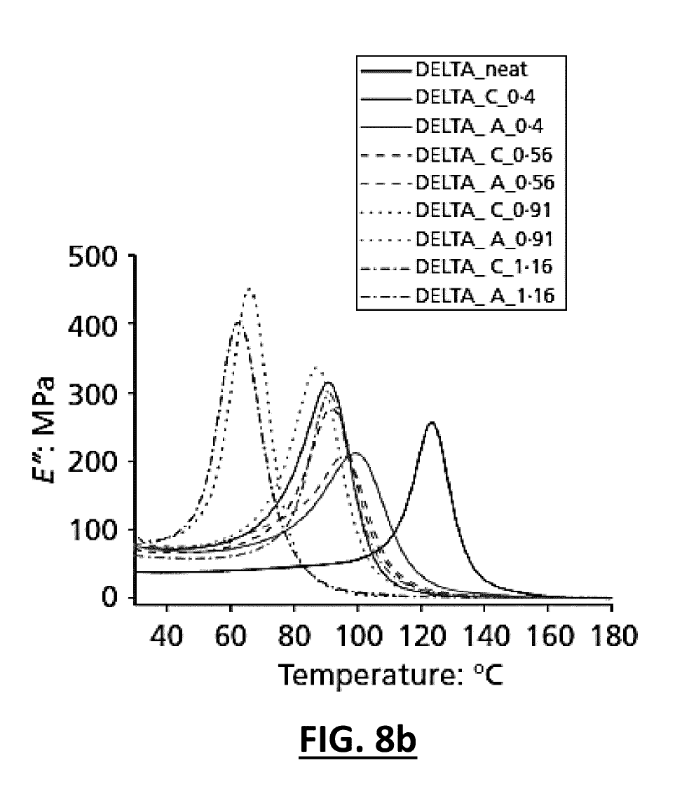

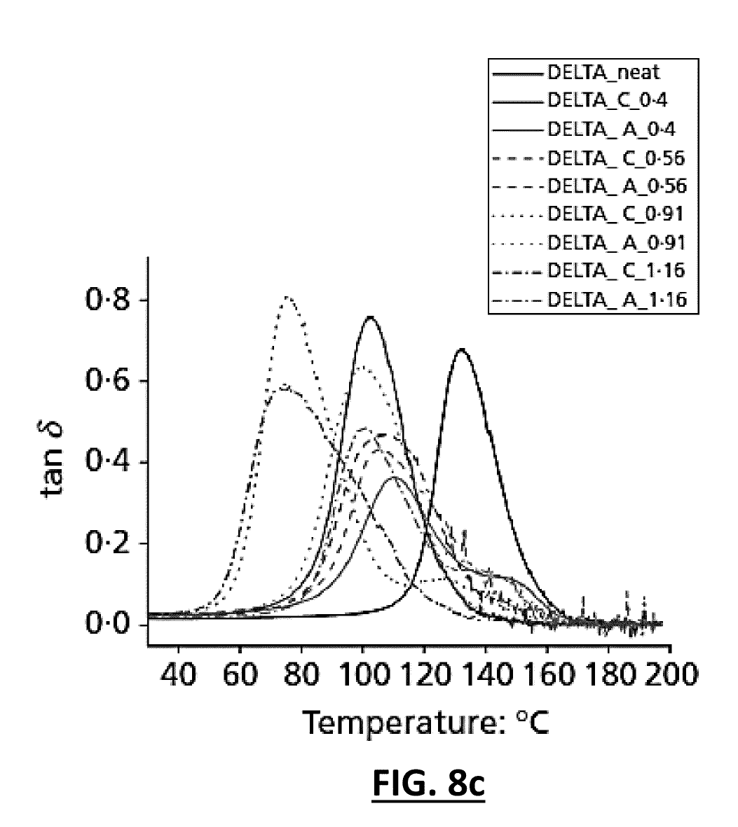

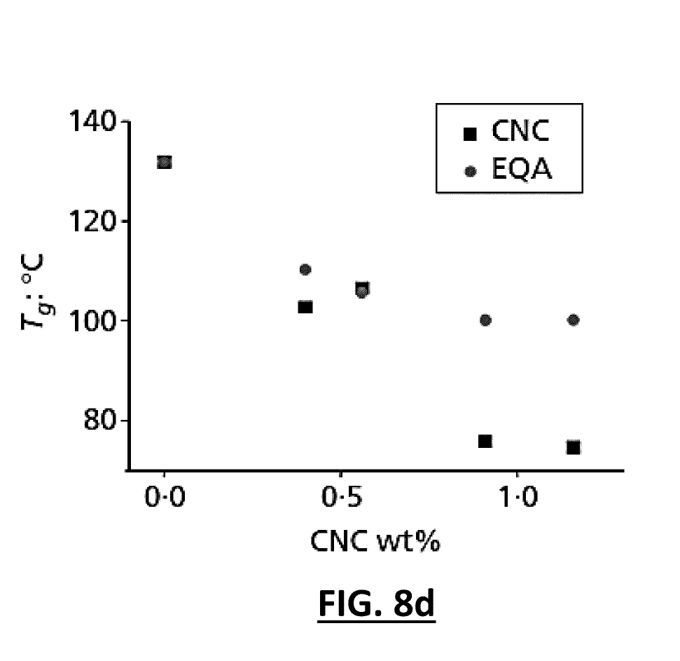

A similar trend was observed for the DETA cured specimens (FIGS. 8a-8d). As shown in FIGS. 8a-8d, T_{g} decreased with CNC additions. Unlike JD400 specimens, the DETA EQA specimens also had a significant decrease of the T_{g}. The addition of CNCs further depressed the T_{g} for the DETA cured specimens.

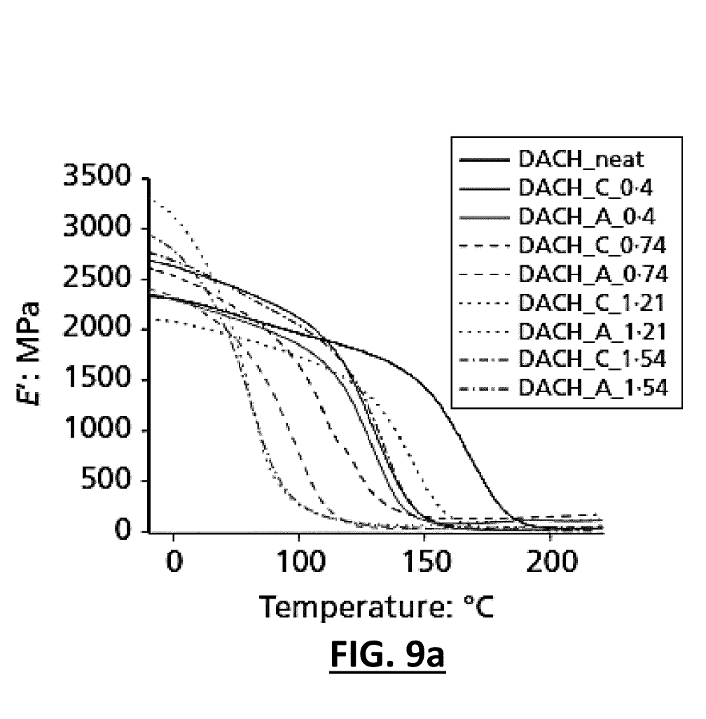

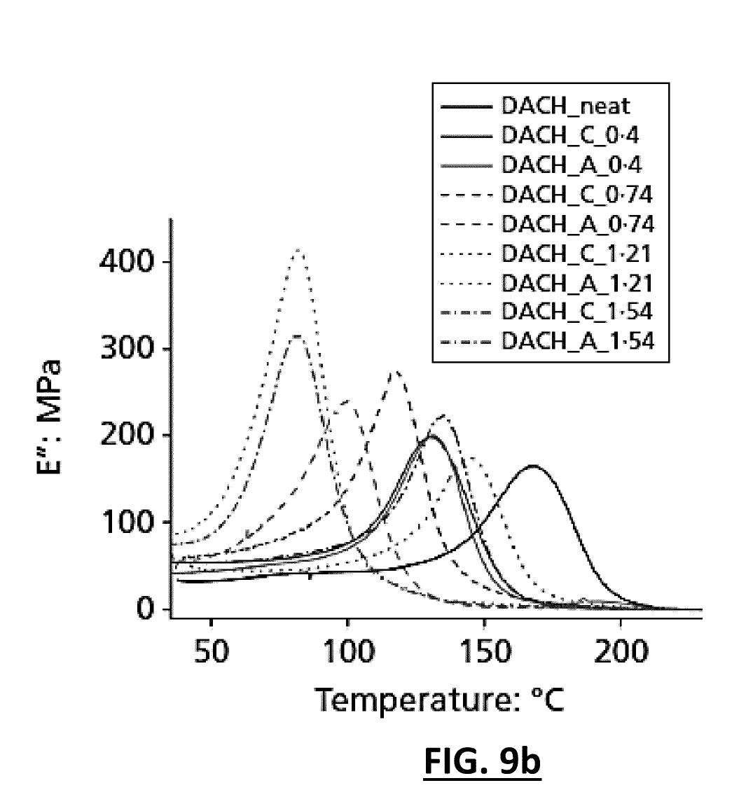

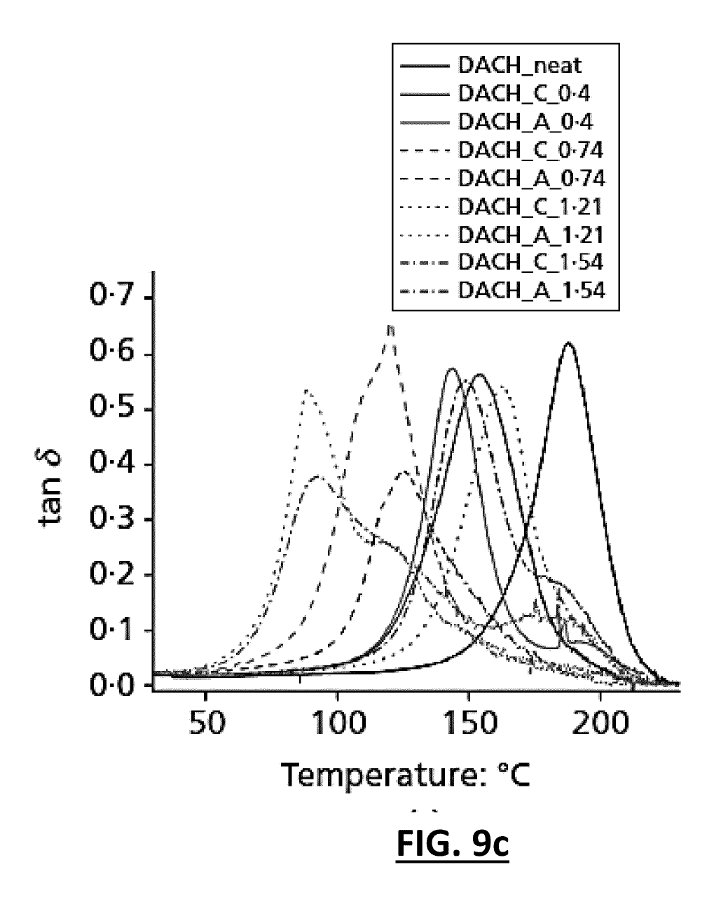

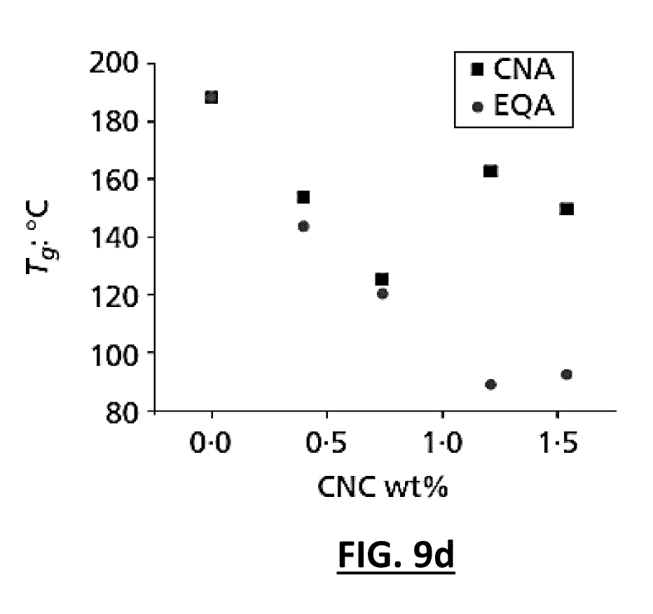

In FIGS. 9a-9d, among the DACH cured specimens, the EQA specimens generally had lower T_{g} than its corresponding CNC specimens. At higher CNC concentrations, there was a rebound of T_{g}. Depressing of T_{g} has been observed before in inorganic nanoparticle reinforced epoxy composite systems. Tang et al. (ACS Appl. Mater. Interfaces 2010, 2, 1073-1080) also observed depressing of T_{g} at low CNC contents in aromatic hardener cured epoxy. However, T_{g} of the cured epoxy increased when CNC contents increased, as CNC formed a rigid percolation network, which limited the movement of polymer chains. In this study, the CNC loading was below the percolation threshold in the cured epoxy. In our system, the water/acetone solvent exchange step could result in residual bound water on the CNC surface. The residual water was carried over to the epoxy resin, which could have led to a decrease of the T_{g} of the cured epoxy. There have been reports that suggested that a small amount of water can accelerate the epoxy curing reaction. However, high levels of water can plasticize the epoxy resin by lowering the degree of cure.

In addition, the temperature dependent curing process could have been affected as solvents absorbed heat during evaporation. The residual solvent may also inhibit the epoxy curing process as dipole-dipole interaction between the solvent and the amine groups of the hardeners could prevent the amine groups from reacting with epoxy. In addition, Liu et al (J. Mater. Sci. 2012, 47, 6891-6895) suggested that nanoparticles could also selectively absorb resin or hardener at its surface, limiting the reaction between epoxy resin and hardener. In this study, since CNC was exposed with hardener first, the weak hydrogen bonding interactions between CNCs and the hardeners could possibly inhibit the epoxy/hardener reaction. These weak interactions of the hardeners, acetone, and CNCs could have caused incomplete curing in some regions of the epoxy and led to formation of inhomogeneous crosslinking networks. In addition to decreasing T_{g}, there was a decrease in the degree of cure caused by the presence of water.

### Example 8

### Comparison of Hardeners on Properties of CNC/Epoxy Nanocomposites

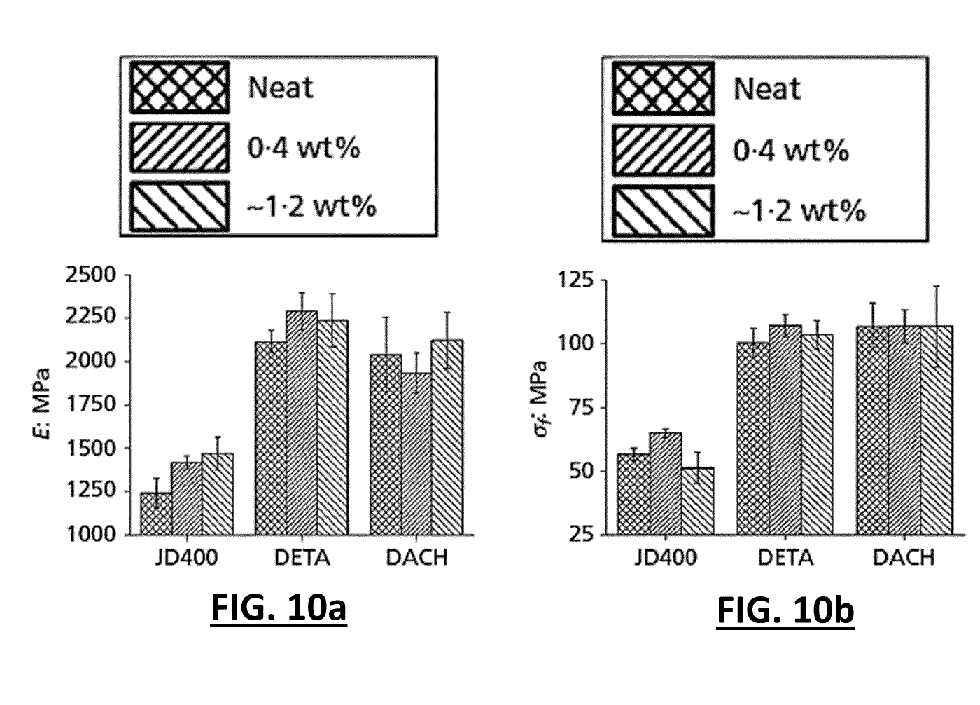

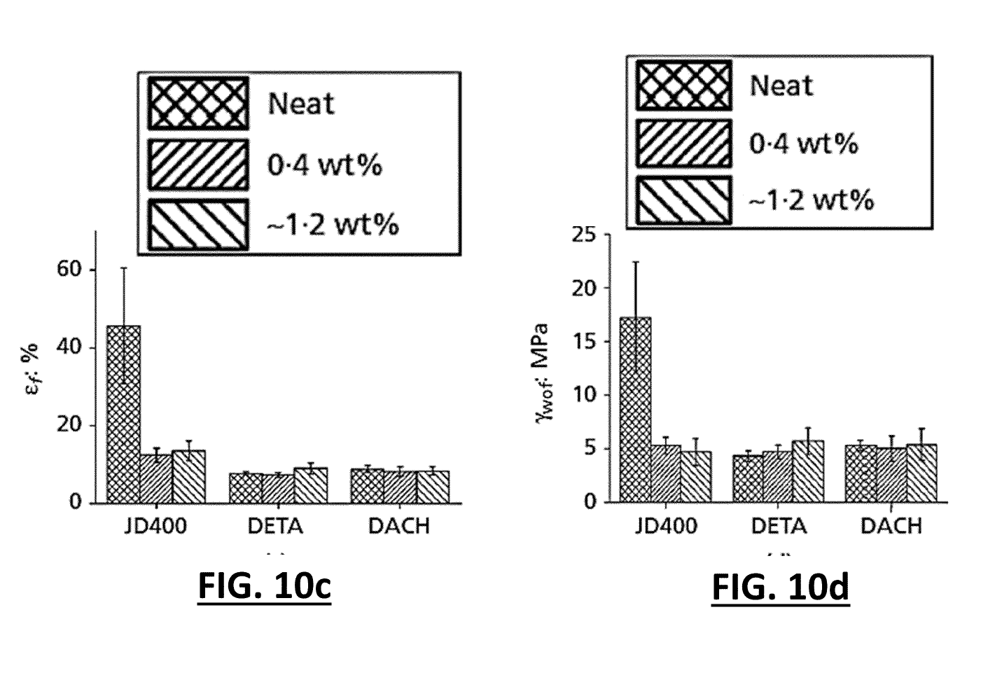

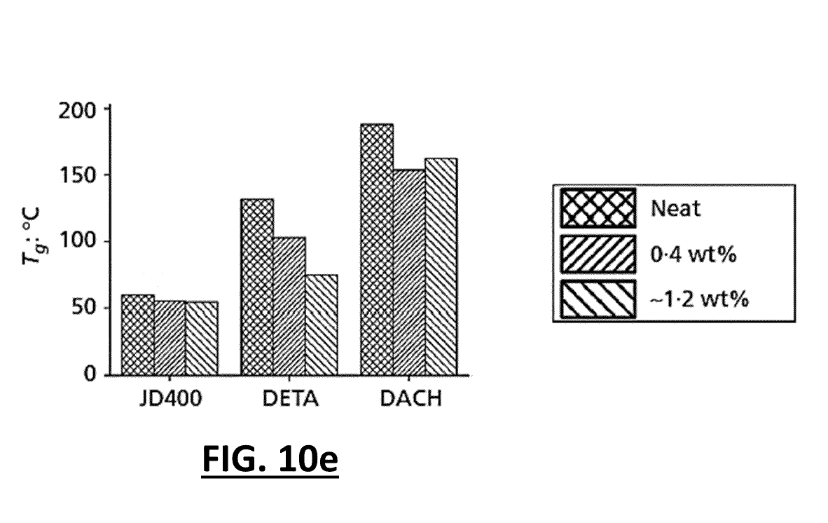

Side-by-side properties comparisons between CNC/epoxy nanocomposites cured with JD400, DETA, and DACH are given in FIGS. 10a-10e. For short chain difunctional hardeners such as JD400, CNC increased Young's modulus of the cured epoxy. The yield strength increased at low CNC concentrations, but decreased at ˜1.2 wt % CNC. As shown in FIGS. 10c and 10d, the strain-at-failure and work-of-fracture for JD400 cured specimens also decreased with CNC additions. T_{g} of JD400 cured epoxy was not significantly affected with the presence of residual water during curing.

For small molecule trifunctional hardeners such as DETA cured epoxy, CNC additions improved Young's modulus, tensile strength, strain-at-failure, and work-of-fracture properties, despite the presence of residual solvent and water, which may have depressed its T_{g}. For high temperature cured cyclic structured difunctional hardeners such as DACH, there was minimal influence on Young's modulus, tensile strength, work-of-fracture, and strain-at-failure with CNC additions. The T_{g} of DACH cured specimens was also lowered with the presence of residual water and acetone during the curing reaction.

From these results, it can be concluded that the method of dispersing CNCs in the hardener first before mixing with epoxy was a viable approach to produce epoxy with improved properties. The degree of improvement depended on the choice of hardeners. Small molecule trifunctional hardeners such as DETA had the highest increase of mechanical properties. The residual acetone and water from the solvent-exchange step affected the curing process of the epoxy and led to plasticization of the cured epoxy. Further, limiting water and solvent during the epoxy curing process is the key to improving the current method.

Those skilled in the art will recognize that numerous modifications can be made to the specific implementations described above. The implementations should not be limited to the particular limitations described. Other implementations may be possible.

What is claimed is:

1. A method for preparing a cellulose nanocrystal (CNC)/epoxy nanocomposite, the method comprising:
a) providing a CNC/hardener/solvent suspension;
b) mixing said CNC/hardener/solvent suspension with an epoxy to form a CNC/hardener/solvent-epoxy mixture; and
c) removing the solvent from said CNC/hardener/solvent-epoxy mixture, followed by curing to form said cellulose nanocrystal (CNC)/epoxy nanocomposite.

2. The method of claim 1, wherein said method further comprises a step of casting the CNC/hardener/solvent-epoxy mixture in a mold prior to step (c).

3. The method of claim 1, wherein said solvent is a water-miscible organic solvent.

4. The method of claim 3, wherein said solvent is acetone.

5. The method of claim 1, wherein said epoxy is bisphenol A diglycidyl ether resin.

6. The method of claim 1, wherein said hardener contains an amino group.

7. The method of claim 1, wherein said hardener contains two or three amino groups.

8. The method of claim 1, wherein said hardener is diethylenetriamine (DETA), Jeffamine D4000 (JD400), or (±)-trans-1,2-diaminocyclohexane (DACH).

9. The method of claim 6, wherein the molar ratio of the epoxide group in the epoxy and the amino group in the hardener is about 1:1.

10. The method of claim 1, wherein said cellulose nanocrystal (CNC) is freeze-dried.

11. The method of claim 1, wherein said removing of the solvent is achieved by degassing.

12. The method of claim 1, wherein said curing is conducted at a temperature of from about 60° C. to about 180° C.

13. The method of claim 2, wherein said method creates a plurality of sheets, films, or fibers.

14. The method of claim 1, wherein said CNC/hardener/solvent suspension is prepared by
a) dispersing a CNC in water to form a CNC/water suspension;
b) adding a solvent to the CNC/water suspension to form a CNC/solvent organogel;
c) removing water from said CNC/solvent organogel; and
d) adding a hardener to said CNC/solvent organogel; and
e) redispersing said CNC/acetone organogel in said hardener to form the CNC/hardener/solvent suspension.

15. The method of claim 14, wherein said CNC/water suspension has a concentration of from about 2 wt % to about 10 wt %.

16. The method of claim 14, wherein the amount of said cellulose nanocrystals (CNCs) used is 0-10 parts by mass based on 100 parts by mass of said hardener.

17. A cellulose nanocrystal (CNC)/epoxy nanocomposite prepared by the method of claim 1, wherein said cellulose nanocrystal (CNC) is in an amount of from about 0.4 wt % to about 2.05 wt %, and wherein said epoxy nanocomposite is cured by Jeffamine D400 (JD400), diethylenetriamine (DETA), or (±)-trans-1,2-diaminocyclohexane (DACH).

18. The cellulose nanocrystal (CNC)/epoxy nanocomposite of claim 17, wherein said epoxy is bisphenol A diglycidyl ether resin.

19. The cellulose nanocrystal (CNC)/epoxy nanocomposite of claim 17, wherein said cellulose nanocrystal (CNC) is in an amount of about 0.6 wt % and wherein said epoxy nanocomposite is cured by diethylenetriamine (DETA).

20. The cellulose nanocrystal (CNC)/epoxy nanocomposite of claim 17, wherein the Young's modulus of said (CNC)/epoxy nanocomposite is increased by from about 15% to about 20% compared with an epoxy nanocomposite without reinforcing cellulose nanocrystals (CNC).
